(19) United States
(12) Patent Application Publication
(10) Pub. No.: US 2026/0089128 A1
(43) Pub. Date: Mar. 26, 2026

(54) DISPLAYING IMAGES IN CHATBOT RESPONSES

(71) Applicant: NVIDIA Corporation, Santa Clara, CA (US)

(72) Inventors: Avinash PATHAK, Pune (IN); Yogesh DANGI, Pune (IN)

(73) Assignee: NVIDIA Corporation, Santa Clara, CA (US)

(21) Appl. No.: 18/895,762

(22) Filed: Sep. 25, 2024

(51) Int. Cl. H04L 51/10; H04L 51/02

(52) U.S. Cl. CPC H04L 51/10; H04L 51/02

(57) ABSTRACT

In various examples, systems and methods are disclosed relating to displaying images in chatbot/NPC/virtual agent/digital avatar/etc. responses. A system can identify text corresponding to an image in an electronic document and can store a representation of the text in association with an identifier of the image. The system can receive an input prompt for a machine-learning model. The system can generate a response to the input prompt using the machine-learning model. The response can include the image responsive to identifying the representation of the text using a searching function and an output of the machine-learning model.

### BACKGROUND

Traditional language models are trained/updated with large corpuses of text to understand and generate natural language data. Certain language models, referred to as multimodal language models, are trained/updated to process information in different media modalities, including images, video, and audio. However, multimodal language models require significantly more computing resources to train/update and execute due to the extra parameters used to implement multimodal capabilities.

### SUMMARY

Conversational agents or chatbots can be implemented using machine-learning models, including large language models (LLMs), vision language models (VLMs), multi-modal language models, etc. Chatbots or conversational agents operate by receiving a natural language text prompt as input, and autoregressively generating a natural language text response to the input text prompt. Previously submitted prompts and previously generated responses may be used as context for further replies, enabling the large language model to operate as a conversational chatbot, virtual agent, non-player character (NPC), digital avatar, etc. Although image or other media data may be helpful to supplement text-based responses for language models, implementing conventional multimodal models for chatbots/conversational agents requires significantly more computing resources compared with typical LLMs.

To address the limitations of conventional approaches, the systems and methods described herein enable responses from language models to be augmented with additional media data without requiring the use of more costly multimodal machine-learning models. To do so, identifiers of images or other media are identified and retrieved during generation of a large language model response and used to provide images as part of chatbot output. Media used to supplement chatbot responses can be extracted from a corpus of documents that include both text data, image data, and/or other media data.

Text data that is proximate to the images/media in the documents are identified as relevant to said images/media, can be extracted and stored in association with a unique identifier of the corresponding image/media data. When a prompt for the chatbot/conversational agent/NPC/digital avatar/etc. is received, a searching function can be used to identify relevant stored text data. Upon identifying relevant text data, the associated identifier of image/media data can be used to retrieve the image/media data for inclusion in the chatbot output. The image/media data, together with the text data generated using the language model of the chatbot/conversational agent, can then be presented as output in response to the initial prompt to provide more context around the response to aid the user during the conversation.

At least one aspect relates to one or more processors. The one or more processors can include one or more circuits. The one or more circuits can identify text corresponding to an image in an electronic document. The one or more circuits can store a representation of the text in association with an identifier of the image. The one or more circuits can receive an input prompt for a machine-learning model. The one or more circuits can generate a response to the input prompt using the machine-learning model, the response to include the image responsive to identifying the representation of the text using a searching function and an output of the machine-learning model.

In some implementations, the one or more circuits can identify the text corresponding to the image by extracting the text proximate to the image in the electronic document. In some implementations, the one or more circuits can identify the text corresponding to the image by extracting a predetermined portion of the text proximate to the image in the electronic document. In some implementations, the one or more circuits can generate the representation of the text by providing the text as input to an embeddings model.

In some implementations, the one or more circuits can store the representation of the text in a vector database. In some implementations, the one or more circuits can store the image in an image database, wherein the image is identified in the image database by the identifier of the image. In some implementations, the one or more circuits can identify a plurality of images using the searching function and the output of the machine-learning model. In some implementations, the one or more circuits can select at least one of the plurality of images for inclusion in the response based at least on an image selection parameter.

In some implementations, the one or more circuits can receive the image selection parameter with the input prompt for the machine-learning model. In some implementations, the one or more circuits can present the output of the machine-learning model with the image via a graphical user interface in response to the input prompt. In some implementations, the searching function comprises a vector similarity searching function.

At least one aspect relates to a system. The system can include one or more processors. The system can receive an input prompt for a machine-learning model. The system can generate a response message using the input prompt and the machine-learning model. The system can identify encoded text data using a searching function and the response message, the encoded text data stored in association with an identifier of an image. The system can provide the response message and the image for display in response to the input prompt.

In some implementations, the encoded text data comprises embeddings data. In some implementations, the search function is a vector search function. In some implementations, the system can identify a set of search results including the encoded text data. In some implementations, the system can select the encoded text data based at least on a similarity between the encoded text data and the response message. In some implementations, the system can extract text data from an electronic document. The text data can be proximate to the image. In some implementations, the system can encode the text data to generate the encoded text data. In some implementations, the system can store the identifier of the image in association with the encoded text data in a database. In some implementations, the system can encode the text using an embeddings model corresponding to the machine-learning model.

At least one aspect is related to a method. The method can include identifying, using one or more processors, text corresponding to media in an electronic document. The method can include storing, using the one or more processors, a representation of the text in association with an identifier of the media. The method can include receiving, using the one or more processors, an input prompt for a machine-learning model. The method can include generating, using the one or more processors, a response to the input prompt using the machine-learning model, the response to include the media responsive to identifying the representation of the text using a searching function and an output of the machine-learning model.

In some implementations, the method can include identifying, using the one or more processors, the text corresponding to the media by extracting the text proximate to the media in the electronic document. The method can include identifying, using the one or more processors, the text corresponding to the media by extracting a predetermined portion of the text proximate to the media in the electronic document. The method can include generating, using the one or more processors, the representation of the text by providing the text as input to an embeddings model.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing generative AI operations using a large language model, a system for performing generative AI operations using a video language model, a system implemented using an edge device, a system implemented using a robot, a system for performing conversational AI operations, a system for generating synthetic data, a system incorporating one or more virtual machines (VMs), a system implemented at least partially in a data center, or a system implemented at least partially using cloud computing resources.

### BRIEF DESCRIPTION OF THE DRAWINGS

The present systems and methods for displaying images in chatbot responses are described in detail below with reference to the attached drawing figures, wherein:

FIG. 1 is a block diagram of an example system for displaying images in chatbot responses, in accordance with some embodiments of the present disclosure;

FIG. 2 depicts an example graphical user interface showing how images can be displayed in chatbot responses, in accordance with some embodiments of the present disclosure;

FIG. 3 is a flow diagram of an example of a method for displaying images in chatbot responses, in accordance with some embodiments of the present disclosure;

FIG. 4A is a block diagram of an example generative language model system suitable for use in implementing at least some embodiments of the present disclosure;

FIG. 4B is a block diagram of an example generative language model that includes a transformer encoder-decoder suitable for use in implementing at least some embodiments of the present disclosure;

FIG. 4C is a block diagram of an example generative language model that includes a decoder-only transformer architecture suitable for use in implementing at least some embodiments of the present disclosure;

FIG. 5 is a block diagram of an example computing device suitable for use in implementing at least some embodiments of the present disclosure; and

FIG. 6 is a block diagram of an example data center suitable for use in implementing at least some embodiments of the present disclosure.

### DETAILED DESCRIPTION

This disclosure relates to systems and methods for providing images, video, and/or other media in responses from chatbots, conversational agents, NPCs, digital avatars, virtual assistants, etc. Conversational agents or chatbots can be implemented using machine-learning models, such as large language models (LLMs). Such machine-learning models are trained/updated using large corpuses or amounts of text data to generate responses based on learned language patterns. Such conventional chatbots operate by receiving a natural language text prompt as input, and autoregressively generating a natural language text response to the input text prompt. Previously submitted prompts and previously generated responses may be used as context for further replies, enabling the large language model to operate as a conversational chatbot.

However, because machine-learning models used to implement conversational agents are trained/updated to operate using natural language text data, such machine-learning models cannot produce images as output. This is disadvantageous for machine-learning models that generate highly technical or nuanced responses, where visual aides may be more suitable than, or may significantly supplement, a natural language response. Although certain machine-learning models, such as vision-based transformer models or multimodal large language models, can produce synthetically generated images as output, such models typically require a large amount of computer resources to train and execute in computing environments.

The systems and methods of the present disclosure address these issues by encoding identifiers of images that can be identified and retrieved during generation of a large language model response. To provide images as part of chatbot output, the systems and methods described herein can process a large corpus of documents that include both text data, video data, image data, audio data, and/or other media types. Text data that is proximate to the images in the documents can be assumed to be relevant to said images. The relevant text may be extracted and associated with a unique identifier of the corresponding image. The images and text data extracted from the database can be stored for later retrieval, for example, using a searching algorithm.

In generating the response, a searching algorithm (such as a vector search operation) can be used to search the database for text entries that are related to the response generated by the machine-learning model of the chatbot. If a related text entry is identified, the identifier of one or more images stored in association with the text entry (e.g., as extracted from the documents) can be accessed and used to retrieve the corresponding image(s), which are provided with the response. Retrieved images may be displayed via a graphical interface with the response generated by the machine-learning model.

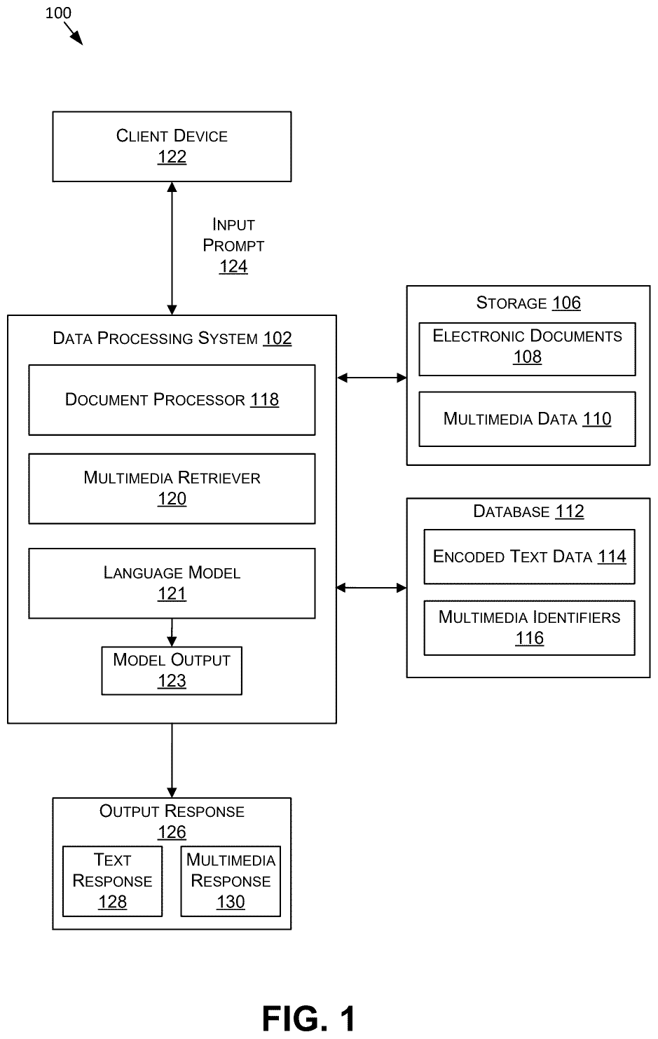

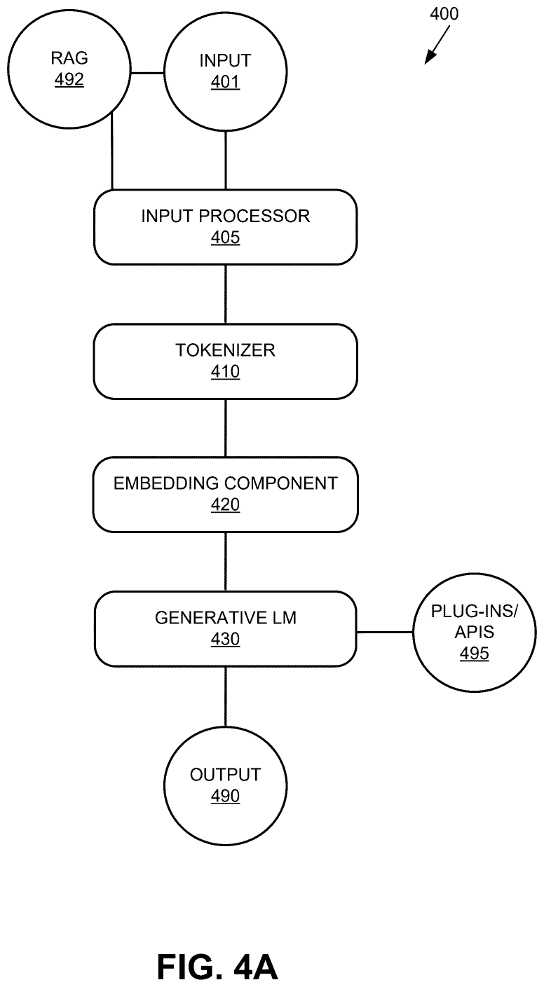

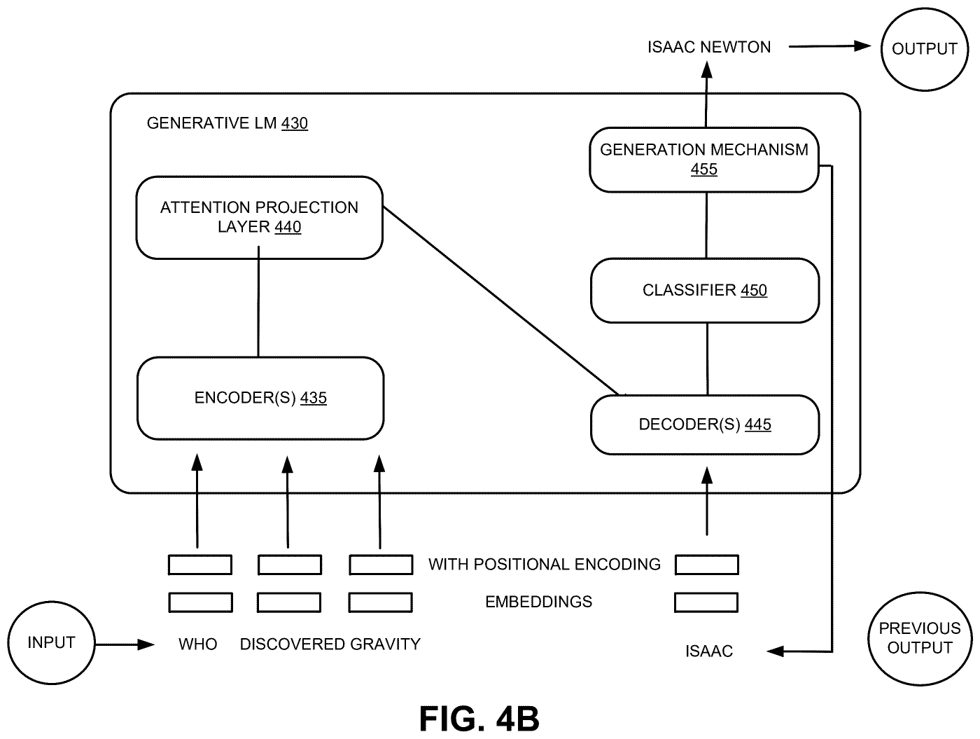

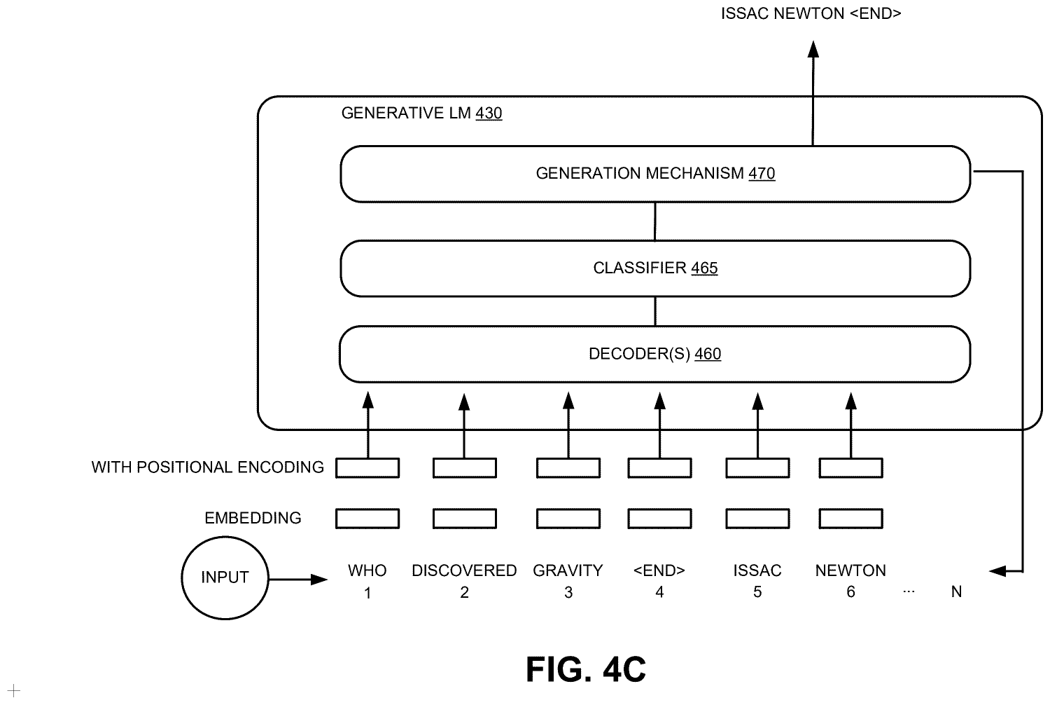

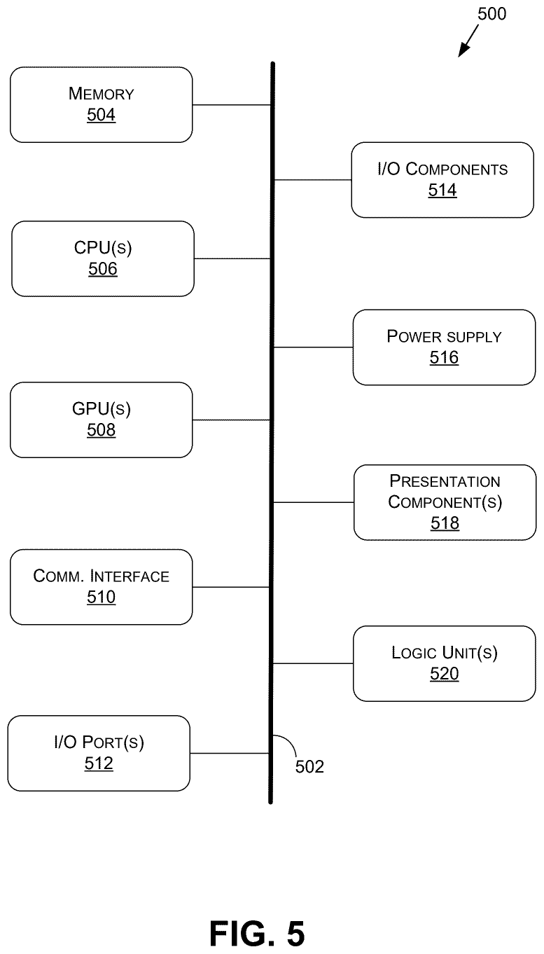

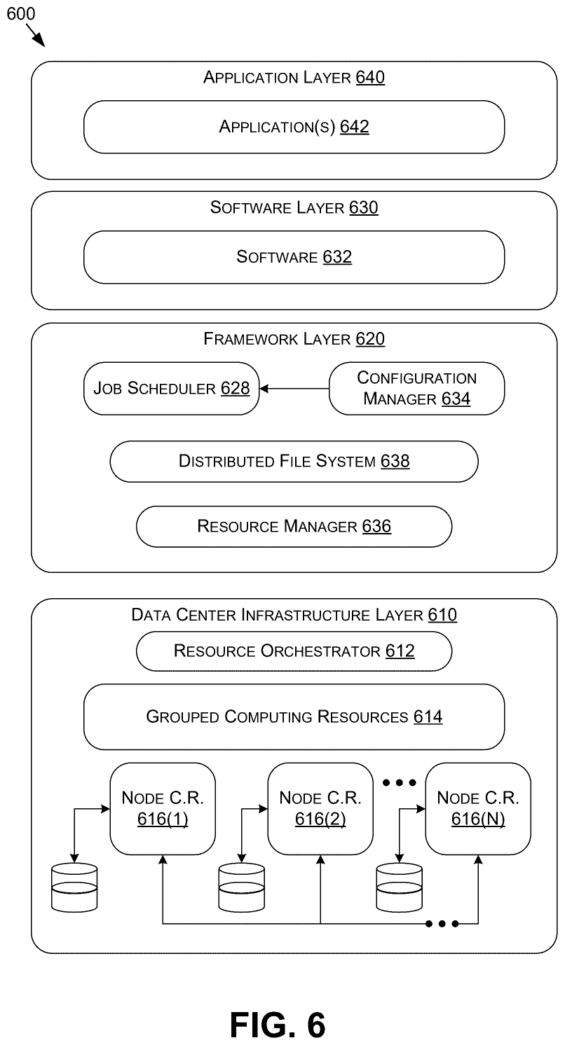

With reference to FIG. 1, FIG. 1 is an example computing environment including a system for displaying images in chatbot responses, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. For example, in some embodiments, the system and methods described herein may be implemented using one or more generative language models (e.g., as described in FIGS. 4A-4C), one or more computing devices or components thereof (e.g., as described in FIG. 5), and/or one or more data centers or components thereof (e.g., as described in FIG. 6).

The system 100 can be used to process electronic documents 108 that include text and image data (e.g., multimedia data 110), such that the images/multimedia data can be included in relevant chatbot responses. The system is shown as including a data processing system 102, storage 106, one or more databases 112, and one or more client devices 122. The data processing system 102 is shown as implementing a document processor 118, a multimedia retriever 120, and a language model 121. The storage 106 is shown as storing one or more electronic documents 108 and multimedia data 110. In some implementations, the multimedia data 110 may be stored in a storage device, system, or database that is separate from the storage 106 (which stores the electronic documents). The database 112 can be separate from, or included as part of the, the storage 106, and is shown as storing encoded text data 114 and multimedia identifiers 116. The data processing system 102 can receive input prompts 124 from the client device 122 and generate output response(s) 126 according to the techniques described herein. The output responses 126 are shown as including a text response 128 and a multimedia response 130.

The data processing system 102 can include one or more processors, circuits, memory, and/or computing devices/systems that can perform the various techniques described herein. The data processing system 102 can be implemented, for example, in a cloud computing environment, which may maintain, update, and/or execute one or more language models 121. The data processing system 102 can implement the various techniques described herein to extract text data and multimedia data 110 from electronic documents 108, and automatically select and provide relevant multimedia data 110 for inclusion in chatbot responses (e.g., the output responses 126).

As shown, in this example, the data processing system 102 is in communication with the storage 106. The storage 106 may be an external server, distributed storage/computing environment (e.g., a cloud storage system), or any other type of storage device or system that is in communication with the data processing system 102. Although shown as external to the data processing system 102, it should be understood that the storage 106 may form a part of, or may otherwise be internal to, the data processing system 102. The storage 106 may be accessed according to any of the multi.

As shown, in this example, the data processing system 102 is in communication with the database 112. The database 112 can be similar to the storage 106, and may be an external server, distributed storage/computing environment (e.g., a cloud storage system), or any other type of storage device or system that is in communication with the data processing system 102. Although shown as external to the data processing system 102, it should be understood that the database 112 may form a part of, or may otherwise be internal to, the data processing system 102. The database 112 may be any type of vector database, which can store encoded text data 114 in association with corresponding multimedia identifier(s) 116.

The storage 106 can store electronic documents 108, for example, in one or more data structures. Although shown as being stored in the storage 106, it should be understood that in some implementations the storage can store identifiers of electronic documents 108, such as hyperlinks or network location identifiers, which identify a network location of the electronic document 108 in one or more networks (e.g., a local network, wide area network, the Internet, etc.). The electronic documents 108 can be any type of electronic document that can include both text and additional media data (e.g., images, audio, video, combinations thereof, etc.).

In some implementations, the electronic documents 108 can include word processing files (e.g., DOCX, ODT), portable document format (PDF) files, presentation files (e.g., PPTX, ODP), or spreadsheets (e.g., XLSX, ODS). In some implementations, the electronic documents 108 can include web pages (e.g., HTML, HTM), e-books (e.g., EPUB, MOBI), or rich text format (RTF) files. The electronic documents 108 may include metadata or other formatting data that indicates location of text data in electronic documents 108 as well as the location(s) of multimedia data 110 in the electronic documents 108, such that the data processing system 102 (or the components thereof) can determine the proximity of text information to the multimedia data 110 in the electronic documents 108.

The multimedia data 110 can include any type/format of image, including but not limited to JPEG, PNG, GIF, BMP, or TIFF images, as well as vector images such as SVG or EPS format images. In some implementations, the multimedia data 110 of the electronic documents 108 may include other types of media in addition to images, including but not limited to audio data in formats such as MP3, WAV, AAC, or FLAC, and video data in formats such as MP4, AVI, MKV, or MOV, among others. In some implementations, the multimedia data 110 embedded in the electronic documents 108 can include multimedia elements such as three-dimensional (3D), and animated images such as graphics interchange format (GIF) images and web media (WEBM) data.

The data processing system 102 can execute the document processor 118 to access electronic documents 108 to populate the database 112. The document processor 118 can include hardware, software, or combinations of hardware and software. The document processor 118 can access one or more of the electronic documents 108. In some implementations, the document processor 118 can process the electronic documents 108, in response to a request received from an external computing device (e.g., a client device 122, another external computing system) or in response to input received from an operator of the data processing system 102. The request may include one or more electronic documents 108 or one or more locations (e.g., uniform resource identifiers (URIs), network locations, etc.) from which to access one or more electronic documents 108. In some implementations, the data processing system 102 may perform web-scraping of one or more servers, websites, or network locations to access and retrieve one or more electronic documents for processing.

To process an electronic document 108, the document processor 118 can parse the electronic document 108 to identify one or more items of multimedia data 110. For example, the document processor 118 can parse the electronic document 108 to identify each item of multimedia data 110 (e.g., each image) in the file, as well as any text data that is proximate to the item of multimedia data 110 (in this example, proximate to the image). In some implementations, the document processor 118 can iterate through the electronic document 18 to extract embedded images, charts, and other media. The document processor 118 can access layout information (e.g., tags, metadata, the structure of the electronic document 108, etc.) to identify the relative distance between portions of text data and multimedia data 110 embedded in the electronic document 108. For example, the layout information may specify relative or absolute location(s) within the document that text data, image data, or other multimedia data 110 are to appear.

Upon identifying text data that is proximate to the multimedia data 110, the document processor 118 can retrieve a portion of the text data to associate with the multimedia data 110. As described herein, text data in electronic documents 108 that is proximate to multimedia data 110 can be assumed to be relevant to the corresponding multimedia data 110. In some implementations, if an item of multimedia data 110 (e.g., an image) is identified in an electronic document, and there is no corresponding text data proximate to the item of multimedia data 110, the document processor 118 may forego further processing with respect to the item of multimedia data 110. Otherwise, if text data proximate to the item of multimedia data 110 is identified, the document processor 118 can extract and store the multimedia data 110 in the storage 106, as shown.

The document processor 118 can also extract at least a portion of the proximate text data. The amount of text data extracted from the electronic document may be predetermined. For example, the document processor 118 may extract a predetermined number of characters, sub-words, words, phrases, sentences, or paragraphs that are identified as proximate to the corresponding item of multimedia data 110. In some implementations, the amount of text data extracted may correspond to the type of electronic document 108 in which the item of multimedia data 110 was identified. For example, if the item of multimedia data 110 is identified in a PDF, DOCX, DOC, RTF, or HTM/HTML document, the document processor 118 can extract a predetermined number of characters (e.g., 500 characters) proximate to the multimedia data 110. In another example, if the item of multimedia data 110 is identified in a presentation document (e.g., PPT, PPTX, etc.), the document processor 118 can extract all text information on the same slide/page as the detected multimedia data 110. Rules/conditions for extracting text data from different types of multimedia data 110 may be stored in configuration settings at the data processing system 102 and may be modified in response to requests from external computing system(s) and/or input from one or more operators of the data processing system 102.

The document processor 118 can generate a unique identifier (e.g., a universally unique identifier (UUID), etc.) for each item of multimedia data 110 extracted from each electronic document 108. The unique identifier of the multimedia data 110 can be stored as part of the multimedia identifiers 116 in the database 112, in association with a corresponding set of encoded text data 114. The document processor 118 can generate the multimedia identifier 116, for example, using a hash function, a timestamp, an identifier of the electronic document 108, combinations thereof, among others. The multimedia identifiers 116 can be stored in the database such that they can be identified by searching over associated encoded text data 114.

The document processor 118 can encode the text data extracted from the electronic document 108 that corresponds to the multimedia data 110. Encoding the text data can include converting the text data to embeddings. In some implementations, encoding the text data can include using one or more embeddings models, which may include pre-trained transformer-based models, which generate contextual embeddings that capture the semantic meaning of the text, and store said embeddings as the encoded text data 114. In some implementations, the text data can be encoded using word2vec or GloVe embeddings, to convert the words of the extracted text data into fixed-length vectors, which are subsequently stored as vectors in the database 112. The encoded text data 114 is shown as being stored in the database 112 (e.g., a vector database) to retrieve corresponding multimedia identifier(s) 116 of multimedia data 110 that was proximate to the corresponding text data. The encoded text data 114 can be searched using a suitable similarity search function, as described in further detail herein, to identify encoded text data 114 that closely matches input prompts 124 provided by client device(s) 122.

The document processor 118 can repeat this extraction process for each item of multimedia data 110 in a set of electronic documents 108 to populate the database 112 with encoded text data 114 and associated unique multimedia identifiers 116. In some implementations, the document processor 118 can iterate over a large corpus of electronic documents 108 covering a diverse range of subjects, topics, or other types of information. In some implementations, the document processor 118 can perform web-scraping of one or more sources of electronic documents 108 periodically, according to a schedule, or in response to request(s) from external computing systems or operator(s) of the data processing system 102, to update the database 112. In some implementations, the document processor 118 can manage (e.g., delete, modify, etc.) one or more entries in the database 112 in response to request(s) from external computing systems or operator(s) of the data processing system 102. For example, automatic or manual review processes may modify encoded text data or may exchange multimedia identifiers 116 to ensure that suitable multimedia data 110 is returned as part of output responses 126.

The data processing system 102 can receive and process input prompts 124 received from one or more client devices 122 using one or more language model(s) 121. The client device 122 can include any type of device that is capable of communicating with the data processing system 102 (e.g., via a network), including but not limited to smartphones, laptop or mobile computers, augmented and/or virtual reality devices, digital assistant devices, accessibility devices (e.g., hearing aids or equipment, etc.) personal computers, servers, cloud computing systems, or other types of computing systems that can provide input prompts 124 to the data processing system 102. In some implementations, the client device 122 can include one or more communications interfaces that enable transmission of input prompts 124 to one or more external computing systems, which may include the data processing system 102.

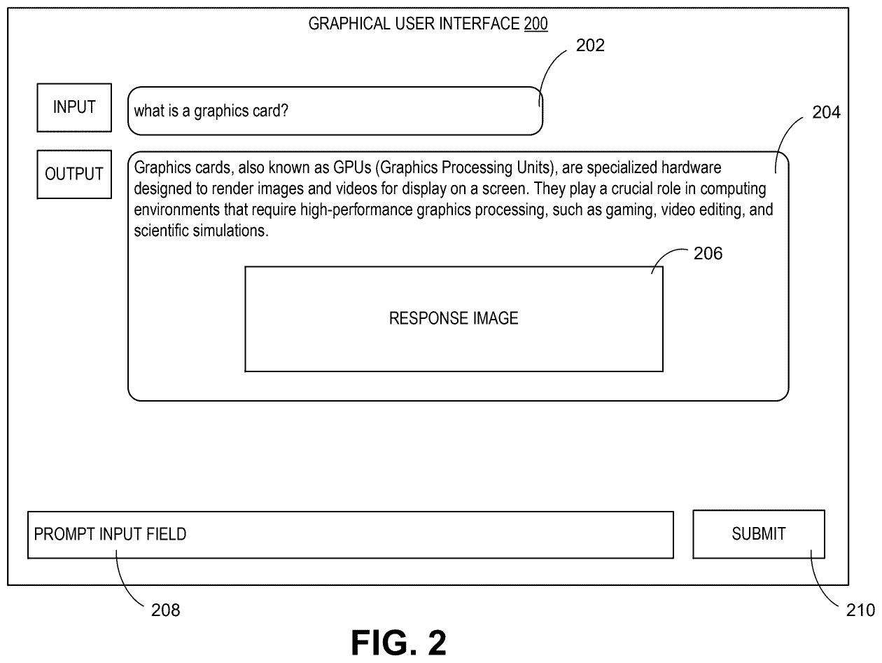

The input prompts 124 can include any type of data that can be provided as input to the one or more language models 121, including but not limited to text data, audio data, or video data, among others. In some implementations, the input prompts 124 can be provided in response to one or more interactions with a graphical user interface (e.g., the graphical user interface of FIG. 2, etc.). The interactions may be provided via one or more input devices of the client device 122, such as via a touchscreen, keyboard, mouse, or other input device. In some implementations, the input prompts 124 can be stored in one or more data structures at the client device 122. In some implementations, the client device 122 can execute one or more applications that enable a user to provide data in one or more input formats, including but not limited to text input, audio input, or video input to provide as input to the language model 121. In some implementations, the application may include a frontend for a conversational agent.

Input prompts 124 generated or retrieved by the client device 122 can be transmitted to the data processing system 102, for processing using the language model 121. In some implementations, the input prompts 124 may be provided via input provided by an operator of the data processing system 102. Upon receiving the input prompts 124, the data processing system 102 can convert the input prompts 124 into a format that is compatible with the language model(s) 121. For example, the data processing system 102 may execute one or more tokenizers to generate a sequence of tokens that represents the input prompt(s) 124 in a numerical format that is compatible with one or more input layers of the language model 121. The sequence of tokens may be stored in association with the input prompt 124, in some implementations.

The data processing system 102 can provide the sequence of input tokens representing the input prompt(s) 124 as input to the language model 121. The language model 121 can be any type of machine-learning model that may be implemented as part of a chatbot or conversational agent. For example, the language model 121 may be or include a transformer-based model (e.g., a generative pre-trained transformer (GPT) model). The language model 121 may be or include an LLM or a vision language model (VLM), in some implementations. In some implementations, the language model 121 may include or may be associated with one or more tokenizers, which as described herein can convert the input prompts 124 into an encoded format (e.g., a sequence of one or more tokens, or a “tokenized” format) that is compatible with the layers of the language model 121.

The data processing system 102 can execute the language model 121 by providing the tokenized input prompt 124 to the input layer(s) of the language model 121. The data processing system 102 can perform the mathematical operations of each layer of the language model 121, propagating the results of each layer to the next layer for processing until one or more output distributions of token probabilities is generated (e.g., from an output softmax layer, etc.). The data processing system 102 can use one or more configuration settings to select one or more tokens from the output distribution(s) for inclusion in output response. The data processing system 102 can execute the large language model 121 autoregressively, to accurately model sequences of output tokens corresponding to natural language. For example, the data processing system 102 can execute the language model 121 to predict one or more next tokens in an output sequence, which can then be included in the input context for the next iteration, as described herein.

The data processing system 102 can execute the language model 121 iteratively, incorporating previously generated tokens as context for generating subsequent tokens, until a termination condition has been reached. One type of termination condition can be a context length limit or a configurable limit on the number of tokens that can be generated and/or processed by the language model 121. In some implementations, the termination condition can be satisfied when the language model 121 generates a token that represents the end of a response. The language model 121 may be trained/updated to be a conversational agent, in some implementations.

The sequence of tokens generated by the language model 121 once the termination condition has been reached can be stored as the model output 123. The model output 123 can be a sequence of output tokens generated by the language model 121 and can be converted into a text format using a detokenizer model. The detokenizer model can be or include any software, hardware, or combination thereof that performs the inverse operations of the tokenizer associated with the language model 121. When converted into a text format, the model output 123 can be provided as a text response 128, shown in this example as part of the output response 126 provided in response to the input prompt 124. The text response 128 may include formatting instructions for displaying the text data that are generated by the language model 121, in some implementations, which may include markdown format instructions, HTML instructions, or other formatting instructions for presenting the text data in the text response 128.

As shown, in addition to the text response 128, the output response 126 includes a multimedia response 130. The multimedia response 130 can include relevant multimedia data 110 identified by the data processing system 102 based on the model output 123, the input prompt 124, or combinations thereof. The multimedia data 110 to include as part of the multimedia response 130 can be identified by searching the database 112 using a search query to identify a corresponding multimedia identifier 116 that is relevant to the search query. To identify relevant multimedia data, the data processing system 102 can execute the multimedia retriever 120.

The multimedia retriever 120 can include any software, hardware, or combinations thereof that can execute one or more search queries over the database 112 to identify relevant encoded text data 114. To do so, the multimedia retriever 120 can generate a search query for the database 112. In some implementations, the multimedia retriever 120 can use the text response 128, the input prompt 124, or both as the search query over the database 112. As described herein, the database 112 can be a vector database. Queries generated for the vector database may be determined using the same encoding process used to generate the encoded text data 114, such that similarity scores can between the query and encoded text data 114 can be calculated using a suitable searching function.

As described herein, encoded text data 114 can be generated from portions of text that are proximate/relevant to multimedia data 110, which can be identified by corresponding multimedia identifiers 116. An entry in the database 112 includes encoded text data 114 stored in association with one or more multimedia identifiers 116 for the relevant/proximate multimedia data 110. To identify relevant multimedia data 110 for inclusion in the output response 126, the multimedia retriever 120 can execute a search query over the database 112 to identify a set of similar/relevant encoded text data 114.

To generate a search query for the database 112, the multimedia retriever 120 can convert the text response 128 and/or the input prompt 124 into an encoded format (e.g., an encoded representation) using the same encoding process used to generate the encoded text data 114. As described herein, this may include executing one or more embeddings models, word2vec processes, or other functions to numerically encode the text response 128 and/or the input prompt 124 in a format that preserves its semantic meaning. In some implementations, the multimedia retriever 120 can generate a vector representation of the text response 128 and/or the input prompt 124 using a pre-trained language model (e.g., the language model 121, another pre-trained language model, etc.). The vector representation can be used as a search query to retrieve relevant encoded text data 114 from the database 112 based on similarity between the vector representation of the search query and the encoded text data 114.

The multimedia retriever 120 can use the generated vector representation (e.g., the search query) to search the database 112 to identify relevant portions of encoded text data 114. Executing the search over the database 112 can include comparing the vector representation of the search query to each encoded text data 114 entry in the database 112 to calculate a respective similarity value. The comparison may be performed using brute-force techniques or approximate nearest neighbor (ANN) techniques to perform the comparison with the entries of the encoded text data 114 in the database 112. In some implementations, locality sensitive hashing (LSH) can be implemented to improve the efficiency of searching the vector database 112. In some implementations, the vector space of the database 112 can be partitioned into KD-trees or ball trees to improve the performance of nearest neighbor searching techniques.

In some implementations, the comparison may be a distance calculation, with a smaller distance indicating a greater similarity between the search query and the entry of the encoded text data 114, and a larger distance indicating a lesser similarity between the search query and the entry of the encoded text data 114. In some implementations, the multimedia retriever 120 can identify the entry of encoded text data 114 in the database 112 having the greatest similarity (e.g., the smallest distance) to the search query. In some implementations, the multimedia retriever 120 can identify a set of top entries of encoded text data 114 in the database 112 having the greatest similarity (e.g., the smallest distance) to the search query. The number of top entries of encoded text data 114 identified by the multimedia retriever 120 can be stored as a “top-k” configuration setting, where k corresponds to the number of entries of encoded text data 114 returned from the search. For example, the “top-k” setting may specify the number of items of multimedia data 110 to provide with the output response 126, and may be equal to one, two, or three items of multimedia data 110.

Once one or more entries of encoded text data 114 have been identified, the multimedia retriever 120 can access the multimedia identifiers 116 associated with the identified entries of encoded text data 114. In some implementations, multimedia identifiers 116 for each of the one or more top entries of encoded text data 114 can be accessed/used regardless of the similarity scores between the top encoded text data 114 and the search query. In some implementations, a multimedia identifier 116 may be accessed for top entries of the encoded text data 114 that satisfy a threshold. The threshold may be stored as a configuration setting, which may be modified via operator input to the data processing system 102 or specified in one or more requests from one or more external computing systems. In some implementations, a single multimedia identifier 116 may be associated with an entry of encoded text data 114 and accessed by the multimedia retriever 120. In some implementations, multiple multimedia identifiers 116 may be associated with an entry of encoded text data 114 and accessed by the multimedia retriever 120.

The multimedia retriever 120 can use the accessed multimedia identifier(s) 116 to retrieve corresponding items of multimedia data 110. As described herein, the multimedia data 110 extracted from the electronic documents 108 may be stored in the storage 106 and/or in one or more multimedia databases (e.g., one or more image databases). The storage and/or the multimedia databases may store the multimedia data 110 such that it can be retrieved using its corresponding unique multimedia identifier 116. In some implementations, the multimedia identifiers 116 may be keys for the database(s) that store the multimedia data 110. In some implementations, the multimedia retriever 120 can use the accessed multimedia identifier(s) 116 as key values to access the multimedia data 110 from the storage 106 (or image database, in some implementations). In some implementations, the multimedia retriever 120 can use the accessed multimedia identifier(s) 116 as part of one or more search queries to retrieve the corresponding multimedia data 110.

The multimedia data 110 accessed by the multimedia retriever 120 can be provided as the multimedia response 130 in the output response 126, as shown. The multimedia response 130 may include one or all of the items of multimedia data 110 retrieved by the multimedia retriever 120. In some implementations, the number of items of multimedia data 110 provided can be specified via a configuration setting, which may be same as, or different from, the top-k for searching the database 112, as described herein. In some implementations, the multimedia retriever 120 can generate the multimedia response 130 as one or more hyperlinks access the multimedia data 110 or display instructions to present the multimedia data 110. The hyperlinks or display instructions can cause the computing system (e.g., the client device 122) that receives the multimedia response 130 to retrieve and present the multimedia data 110 identified by the hyperlinks or display instructions. In an implementation where one or more hyperlinks are provided, the computing system that receives the multimedia response 130 may display the hyperlink with one or more indications of the name, type, or other attributes of the multimedia data 110 identified by the hyperlink.

Once generated, the output response 126 (including the text response 128 and the multimedia response 130) can be provided to one or more computing systems in response to the input prompt 124. For example, the output response 126 can be provided to the client device 122 that transmitted the input prompt 124 and may be stored in storage 106 in association with a record of the input prompt 124, in some implementations. The data processing system 102 may store/maintain a record of one or more conversations in a log, which may include sequences of input prompt(s) 124 and corresponding output responses 126, to implement a conversational agent/chatbot. In some implementations, the input prompt(s) 124 and the corresponding output response(s) 126 may be stored in one or more historical conversation repositories for use in future training/update processes for the language model 121 or other machine-learning models. An example of a graphical user interface showing an example output response 126 is described in connection with FIG. 2.

Referring to FIG. 2 in the context of the components described in connection with FIG. 1, illustrated is an example graphical user interface 200 showing how images/multimedia data can be displayed in chatbot responses 204, in accordance with some embodiments of the present disclosure. The graphical user interface 200 may be a web-based interface or an interface provided within a client application executing on a client device 122. In some implementations, the graphical user interface 200 may be provided by the data processing system 102 and presented at a client device 122. For example, the graphical user interface may be provided directly via a web interface by the data processing system 102 and/or indirectly via a client application at least partially supported by the data processing system 102.

As shown, the graphical user interface 200 includes a region in which responses generated by the data processing system 102 are presented. The graphical user interface 200 includes a prompt input field 208, which can receive natural language prompts via user input. In some implementations, the prompt input field 208 may be populated via speech-to-text or other alternative input techniques. The graphical user interface 200 can include submit button 210, which when interacted with causes the data processing system 102 to transmit the text/information in the prompt input field 208 to the data processing system 102.

FIG. 2 shows the graphical user interface 200 after the input prompt 202 (e.g., an input prompt 124) has been transmitted, which in this example reads “what is a graphics card?”. In response to the input prompt 202, an output response 204 (e.g., an output response 126) is generated (e.g., by the data processing system 102 according to the techniques described herein) and displayed below the input prompt 202. The output response 204 is shown as including a text response (e.g., the text response 128), which in this example explains details of graphics cards in natural language. The text response may be generated by the language model 121, as described herein. In addition, the output response 204 includes one or more response images 206 (e.g., the multimedia response 130).

In some implementations, instead of the multimedia data of the output response 204 being an image, the multimedia data may include one or more videos, audio, and/or other types of multimedia data. Further, although the response image 206 is shown as being positioned below the text data of the output response 204, the response image 206 may be positioned in any location within the output response 204 or the graphical user interface 200, in some implementations. In some implementations, instructions for displaying the response image(s) 206 (or other multimedia data), which may specify the size, position, or other attributes of the multimedia response 130, can be provided by the data processing system 102 with the output response 204. In some implementations, these instructions may be generated by the language model 121 using a corresponding input prompt requesting generation of display instructions for the response image(s) 206.

In some examples, one or more of the machine learning models (e.g., language models) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model (e.g., weights and biases). In some instances, such as where the machine learning model is small enough (e.g., has a small enough number of parameters), the model may be included within the container itself. In other examples—such as where the model is large—the model may be hosted/stored in the cloud (e.g., in a data center) and/or may be hosted on-premises and/or at the edge (e.g., on a local server or computing device, but outside of the container). In such embodiments, the model may be accessible via one or more APIs-such as REST APIs. As such, and in some embodiments, the machine learning models described herein may be deployed as an inference microservice to accelerate deployment of models on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the language model and/or the image database hosted on the local and/or remote servers using one or more APIs—such as, without limitation, REST APIs.

In one or more embodiments, the system and methods described herein may be deployed in a gaming application. For example, a gaming console, PC, tablet, or other gaming device may include one or more onboard processors (e.g., CPUs, GPUs, deep learning accelerators, SoCs) and memory and/or storage (e.g., for storing the game model, game assets, player data, etc.). These devices may use one or more machine learning models (e.g., language models) to enhance gameplay, generate real-time dynamic content, and personalize user experiences based on in-game behavior or pre-stored player profiles. In some embodiments, the system may be deployed in a cloud gaming environment. In such cases, a client device (e.g., a smart display, tablet, or gaming controller) may be used to interact with the game, while the language model(s) and/or visual rendering may occur on one or more remotely located servers/computing devices (e.g., in one or more data centers). The language model and/or AI processing described herein may operate in the cloud, processing player inputs and generating appropriate in-game responses.

In some embodiments, the system and methods described herein may be deployed in a video conferencing application. For example, a video conferencing device, such as a dedicated conferencing unit, computer, tablet, or smartphone, may include one or more onboard processors (e.g., CPUs, GPUs, deep learning accelerators, SoCs) and memory and/or storage (e.g., for storing the video, audio, or other communication-related data). The system may use the language model(s) to enhance video conferencing functionality, including real-time transcription, language translation, and background noise reduction. In one or more embodiments, the system may enable users to interact with the video conferencing platform using natural language inputs. For example, users may issue voice commands to schedule, join, or leave meetings, or to manage participants and screen sharing.

In some embodiments, the system and methods described herein may be deployed in a robotics application. For example, a robot or robotic system may include one or more onboard processors (e.g., CPUs, GPUs, deep learning accelerators, SoCs) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet.

In some embodiments, the system and methods described herein may be deployed in an in-vehicle infotainment (IVI) system. For example, the infotainment system within a vehicle (e.g., cars, trucks, or autonomous vehicles) may include one or more onboard processors (e.g., CPUs, GPUs, deep learning accelerators, SoCs) and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time.

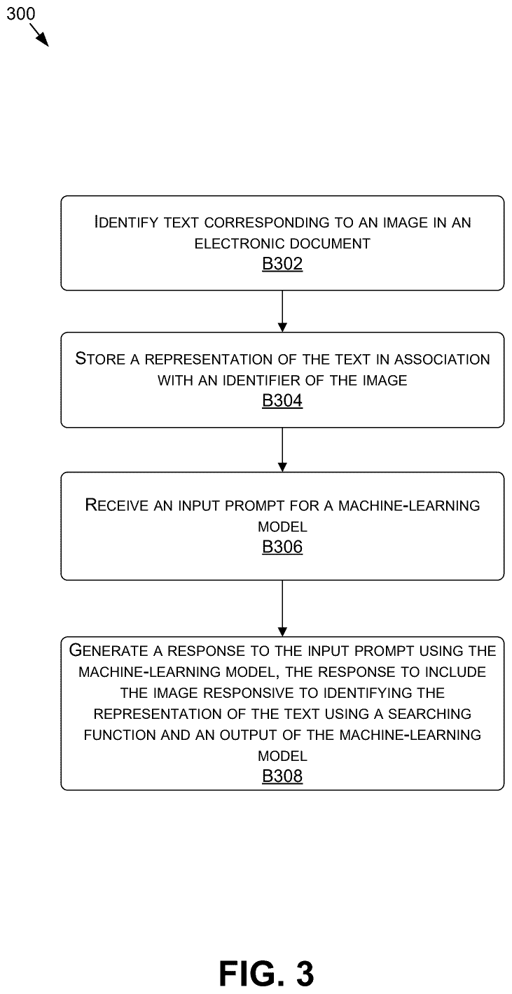

Now referring to FIG. 3, each block of method 300, described herein, includes a computing process that may be performed using any combination of hardware, firmware, and/or software. For instance, various functions may be carried out by one or more processors executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1. However, this method may additionally or alternatively be executed by any one system, or any combination of systems, including, but not limited to, those described herein.

FIG. 3 is a flow diagram showing a method 300 for displaying images in chatbot responses, in accordance with some embodiments of the present disclosure. The method 300, at block B302, includes identifying text corresponding to an image in an electronic document (e.g., an electronic document 108). The electronic document 108 may be any type of document, including word processor documents (e.g., DOCX, DOC, PDF, etc.) presentation documents (e.g., PPT, PPTX, etc.), spreadsheet documents, webpages, or other types of documents. The electronic document can be parsed to identify each item of multimedia data (e.g., multimedia data 110) in the electronic document. In some implementations, the electronic document may include text data as well as multimedia data (e.g., image data).

The text corresponding to the image can be identified as text in the electronic document that is proximate to the image. Proximity may be determined based on layout instructions or metadata specified in the electronic document, in some implementations. For example, the proximate text may include a caption or relevant description of the image/multimedia data. Text identified as proximate to the image can be extracted from the electronic document for further processing. In some implementations, a predetermined number of characters, sub-words, words, phrases, sentences, or paragraphs of the proximate text data can be extracted. For example, five-hundred characters of proximate text data may be extracted from the electronic document.

Additionally, the image/multimedia data can be extracted from the electronic document and can be stored in a repository (e.g., the storage 106, an image database, etc.). An identifier (e.g., a multimedia identifier 116) for each item of extracted image/multimedia data can be generated to uniquely identify the image/multimedia data in the repository. The generated identifiers may be or include UUIDs for each image or item of multimedia data extracted from the electronic document.

The method 300, at block B304, includes storing a representation of the text (e.g., the encoded text data 114) in association with an identifier of the image. The representation of the text data may be generated by encoding the text data extracted from the electronic document into a vector format and storing the encoded text data in a vector database (e.g., the database 112) in association with the identifier of the corresponding image/multimedia data. In some implementations, the encoded text data can be generated by providing the text as input to an embeddings model and/or a pre-trained language model. In some implementations, the encoded text data can be generated using a word2vec model, or similar vectorization function for text information that preserves the semantic meaning of the text data. The encoded text data can be used as a key in the vector data for the unique identifier for the corresponding image/multimedia data.

The method 300, at block B306, includes receiving an input prompt (e.g., the input prompt 124) for a machine-learning model (e.g., the language model 121). The input prompt may be received from a client device (e.g., a client device 122) or from an operator of the computing system performing the method 300. The input prompts can include any type of data that can be provided as input to a language model, including but not limited to text data, audio data, or video data, among others. In some implementations, the input prompts can be provided in response to one or more interactions with a graphical user interface (e.g., the graphical user interface of FIG. 2, etc.). The input prompts may be provided via a frontend for a chatbot or conversational agent.

The method 300, at block B308, includes generating a response (e.g., the output response 126) to the input prompt using the machine-learning model. The response can be generated to include the image (e.g., the multimedia response 130) in response to identifying the representation of the text using a searching function and an output of the machine-learning model. For example, once an input prompt is received, the input prompt can be provided as input to the machine-learning model to generate a text-based output (e.g., the text response 128). The text response can be used to identify relevant media data that is to be provided as part of the response.

To identify relevant media data, the text response and/or the input prompt can be encoded using the same encoding process used to generate the encoded representation of text data extracted from electronic documents, as described herein. The encoded data is then used to perform a search query over the database (e.g., database 112) that stores the encoded text data and corresponding multimedia identifiers. The search function may be a vector search function, which may return a predetermined number (e.g., according “top-k” configuration setting) of results that identify corresponding multimedia identifiers. The multimedia identifier(s) that are most similar/relevant to the search query can be used to retrieve the corresponding multimedia data (e.g., the image) from the repository where the extracted multimedia data is stored (e.g., the storage 106, an image database, etc.). The retrieved images can be provided with the text response as an output response message in response to the input prompt, as described in connection with FIG. 1. An example of the output response, including text and an image response, is shown in FIG. 2.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), light transport simulation (e.g., ray-tracing, path tracing, etc.), collaborative content creation for three-dimensional (3D) assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs), systems for performing light transport simulation, systems for performing collaborative content creation for 3D assets, systems implemented at least partially using cloud computing resources, and/or other types of systems.

### EXAMPLE LANGUAGE MODELS

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 4A is a block diagram of an example generative language model system 400 suitable for use in implementing at least some embodiments of the present disclosure. In the example illustrated in FIG. 4A, the generative language model system 400 includes a retrieval augmented generation (RAG) component 492, an input processor 405, a tokenizer 410, an embedding component 420, plug-ins/APIs 495, and a generative language model (LM) 430 (which may include an LLM, a VLM, a multi-modal LM, etc.).

At a high level, the input processor 405 may receive an input 401 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 430 (e.g., LLM/VLM/MMLM/etc.). In some embodiments, the input 401 includes plain text in the form of one or more sentences, paragraphs, and/or documents. Additionally or alternatively, the input 401 may include numerical sequences, precomputed embeddings (e.g., word or sentence embeddings), and/or structured data (e.g., in tabular formats, JSON, or XML). In some implementations in which the generative LM 430 is capable of processing multi-modal inputs, the input 401 may combine text (or may omit text) with image data, audio data, video data, design data, USD data, and/or other types of input data, such as but not limited to those described herein. Taking raw input text as an example, the input processor 405 may prepare raw input text in various ways. For example, the input processor 405 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 405 may remove stopwords to reduce noise and focus the generative LM 430 on more meaningful content. The input processor 405 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 492 (which may include one or more RAG models, and/or may be performed using the generative LM 430 itself) may be used to retrieve additional information to be used as part of the input 401 or prompt. RAG may be used to enhance the input to the LLM/VLM/MMLM/etc. with external knowledge, so that answers to specific questions or queries or requests are more relevant—such as in a case where specific knowledge is required. The RAG component 492 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 401 may be generated using the query or input to the model (e.g., a question, a request, etc.) in addition to data retrieved using the RAG component 492. In some embodiments, the input processor 405 may analyze the input 401 and communicate with the RAG component 492 (or the RAG component 492 may be part of the input processor 405, in embodiments) in order to identify relevant text and/or other data to provide to the generative LM 430 as additional context or sources of information from which to identify the response, answer, or output 490, generally. For example, where the input indicates that the user is interested in a desired tire pressure for a particular make and model of vehicle, the RAG component 492 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 492 may retrieve a prior stored conversation history—or at least a summary thereof—and include the prior conversation history along with the current ask/request as part of the input 401 to the generative LM 430.

The RAG component 492 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 492 and the embeddings of the chunks along with the embeddings of the query may be compared to identify the most similar/related embeddings to the query, which may be supplied to the generative LM 430 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may strore relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 492 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 410 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 430 to understand morphological variations and handle out-of-vocabulary words more effectively. Character-based tokenization represents each character as a separate token, enabling the generative LM 430 to process text at a fine-grained level. The choice of tokenization strategy may depend on factors such as the language being processed, the task at hand, and/or characteristics of the training dataset. As such, the tokenizer 410 may convert the (e.g., processed) text into a structured format according to tokenization schema being implemented in the particular embodiment.

The embedding component 420 may use any known embedding technique to transform discrete tokens into (e.g., dense, continuous vector) representations of semantic meaning. For example, the embedding component 420 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 401 includes image data/video data/etc., the input processor 401 may resize the data to a standard size compatible with format of a corresponding input channel and/or may normalize pixel values to a common range (e.g., 0 to 1) to ensure a consistent representation, and the embedding component 420 may encode the image data using any known technique (e.g., using one or more convolutional neural networks (CNNs) to extract visual features). In some implementations in which the input 401 includes audio data, the input processor 401 may resample an audio file to a consistent sampling rate for uniform processing, and the embedding component 420 may use any known technique to extract and encode audio features—such as in the form of a spectrogram (e.g., a mel-spectrogram). In some implementations in which the input 401 includes video data, the input processor 401 may extract frames or apply resizing to extracted frames, and the embedding component 420 may extract features such as optical flow embeddings or video embeddings and/or may encode temporal information or sequences of frames. In some implementations in which the input 401 includes multi-modal data, the embedding component 420 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 430 and/or other components of the generative LM system 400 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 420 may apply an encoded representation of the input 401 to the generative LM 430, and the generative LM 430 may process the encoded representation of the input 401 to generate an output 490, which may include responsive text and/or other types of data.

As described herein, in some embodiments, the generative LM 430 may be configured to access or use—or capable of accessing or using—plug-ins/APIs 495 (which may include one or more plug-ins, application programming interfaces (APIs), databases, data stores, repositories, etc.). For example, for certain tasks or operations that the generative LM 430 is not ideally suited for, the model may have instructions (e.g., as a result of training, and/or based on instructions in a given prompt, such as those retrieved using the RAG component 492) to access one or more plug-ins/APIs 495 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 495 to the plug-in/API 495, the plug-in/API 495 may process the information and return an answer to the generative LM 430, and the generative LM 430 may use the response to generate the output 490. This process may be repeated—e.g., recursively—for any number of iterations and using any number of plug-ins/APIs 495 until an output 490 that addresses each ask/question/request/process/operation/etc. from the input 401 can be generated. As such, the model(s) may not only rely on its own knowledge from training on a large dataset(s) and/or from data retrieved using the RAG component 492, but also on the expertise or optimized nature of one or more external resources—such as the plug-ins/APIs 495.

FIG. 4B is a block diagram of an example implementation in which the generative LM 430 includes a transformer encoder-decoder. For example, assume input text such as “Who discovered gravity” is tokenized (e.g., by the tokenizer 410 of FIG. 4A) into tokens such as words, and each token is encoded (e.g., by the embedding component 420 of FIG. 94A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 435 of the generative LM 430.

In an example implementation, the encoder(s) 435 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 440 may convert the context vector into attention vectors (keys and values) for the decoder(s) 445.

In an example implementation, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 may generate a first token, and the generation mechanism 455 may apply the generated token as an input during a second pass. The process may repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 may output some decoded (e.g., vector) representation of the input being applied during a particular pass. The classifier 450 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 may select or sample a word or token based on a corresponding predicted probability (e.g., select the word with the highest predicted probability) and append it to the output from a previous pass, generating each word or token sequentially. The generation mechanism 455 may repeat the process, triggering successive decoder inputs and corresponding predictions until selecting or sampling a symbol or token that represents the end of the response, at which point, the generation mechanism 455 may output the generated response.

FIG. 4C is a block diagram of an example implementation in which the generative LM 430 includes a decoder-only transformer architecture. For example, the decoder(s) 460 of FIG. 4C may operate similarly as the decoder(s) 445 of FIG. 4B except each of the decoder(s) 460 of FIG. 4C omits the encoder-decoder self-attention layer (since there is no encoder in this implementation). As such, the decoder(s) 460 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 460. As with the decoder(s) 445 of FIG. 4B, each token (e.g., word) may flow through a separate path in the decoder(s) 460, and the decoder(s) 460, a classifier 465, and a generation mechanism 470 may use auto-regression to sequentially generate one token at a time until predicting a symbol or token that represents the end of the response. The classifier 465 and the generation mechanism 470 may operate similarly as the classifier 450 and the generation mechanism 455 of FIG. 4B, with the generation mechanism 470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### EXAMPLE COMPUTING DEVICE

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### EXAMPLE DATA CENTER

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may use distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
identify text corresponding to an image in an electronic document;
store a representation of the text in association with an identifier of the image;
receive an input prompt for a machine-learning model; and
generate a response to the input prompt using the machine-learning model, the response to include the image responsive to identifying the representation of the text using a searching function and an output of the machine-learning model.

2. The one or more processors of claim 1, wherein the one or more circuits are to:
identify the text corresponding to the image by extracting the text proximate to the image in the electronic document.

3. The one or more processors of claim 2, wherein the one or more circuits are to:
identify the text corresponding to the image by extracting a predetermined portion of the text proximate to the image in the electronic document.

4. The one or more processors of claim 1, wherein the one or more circuits are to:
generate the representation of the text by providing the text as input to an embeddings model.

5. The one or more processors of claim 1, wherein the one or more circuits are to:
store the representation of the text in a vector database; and
store the image in an image database, wherein the image is identified in the image database by the identifier of the image.

6. The one or more processors of claim 1, wherein the one or more circuits are to:
identify a plurality of images using the searching function and the output of the machine-learning model; and
select at least one of the plurality of images for inclusion in the response based at least on an image selection parameter.

7. The one or more processors of claim 6, wherein the one or more circuits are to:
receive the image selection parameter with the input prompt for the machine-learning model.

8. The one or more processors of claim 1, wherein the one or more circuits are to:
present the output of the machine-learning model with the image via a graphical user interface responsive to the input prompt.

9. The one or more processors of claim 1, wherein the searching function comprises a vector similarity searching function.

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a multi-modal language model;
a system for performing generative AI operations using a large language model (LLM);
a system for performing generative AI operations using a video language model (VLM);
a system for generating synthetic data;
a system incorporating one or more virtual machines (VMs);
a system implemented at least partially in a data center; or
a system implemented at least partially using cloud computing resources.

11. A system, comprising:
one or more processors to:
receive an input prompt for a machine-learning model;
generate a response message using the input prompt and the machine-learning model;
identify encoded text data using a searching function and the response message, the encoded text data stored in association with an identifier of an image; and
provide the response message and the image for display in response to the input prompt.

12. The system of claim 11, wherein the encoded text data comprises embeddings data, and wherein the searching function is a vector search function.

13. The system of claim 12, wherein the one or more processors are to:
identify a set of search results including the encoded text data; and
select the encoded text data based at least on a similarity between the encoded text data and the response message.

14. The system of claim 11, wherein the one or more processors are to:
extract text data from an electronic document, the text data proximate to the image;
encode the text data to generate the encoded text data; and
store the identifier of the image in association with the encoded text data in a database.

15. The system of claim 14, wherein the one or more processors are to:
encode the text data using an embeddings model corresponding to the machine-learning model.

16. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a multi-modal language model;
a system for performing generative AI operations using a large language model (LLM);
a system for performing generative AI operations using a video language model (VLM);
a system for generating synthetic data;
a system incorporating one or more virtual machines (VMs);
a system implemented at least partially in a data center; or a system implemented at least partially using cloud computing resources.

17. A method, comprising:
identifying, using one or more processors, text corresponding to media in an electronic document;
storing, using the one or more processors, a representation of the text in association with an identifier of the media;
receiving, using the one or more processors, an input prompt for a machine-learning model; and
generating, using the one or more processors, a response to the input prompt using the machine-learning model, the response to include the media responsive to identifying the representation of the text using a searching function and an output of the machine-learning model.

18. The method of claim 17, further comprising:
identifying, using the one or more processors, the text corresponding to the media by extracting the text proximate to the media in the electronic document.

19. The method of claim 18, further comprising:
identifying, using the one or more processors, the text corresponding to the media by extracting a predetermined portion of the text proximate to the media in the electronic document.

20. The method of claim 17, further comprising:
generating, using the one or more processors, the representation of the text by providing the text as input to an embeddings model.
